(19) United States
(12) Patent Application Publication
(10) Pub. No.: US 2026/0043623 A1
(43) Pub. Date: Feb. 12, 2026

(54) REFRIGERANT MODULE FOR THERMAL MANAGEMENT SYSTEM

(71) Applicant: VALEO SYSTEMES THERMIQUES, Le Mesnil-Saint-Denis (FR)

(72) Inventors: Andreas Fiene, Bad Rodach (DE); Satyam Hedaoo, Chennai (IN)

(73) Assignee: VALEO SYSTEMES THERMIQUES, Le Mesnil-Saint-Denis (FR)

(21) Appl. No.: 19/100,369

(22) PCT Filed: Jul. 12, 2023
(86) PCT No.: PCT/EP2023/069400

§ 371 Date: Jan. 31, 2025

(30) Foreign Application Priority Data
Aug. 1, 2022 (EP) 22188147.7

(51) Int. Cl. F28F 9/02; F25B 41/20; F25B 41/40; F28F 3/12; F28F 9/26

(52) U.S. Cl. CPC F28F 9/0253; F25B 41/20; F25B 41/40; F28F 3/12; F28F 9/26; F28F 2275/04

(57) ABSTRACT

A refrigerant module for a thermal management system, includes a first refrigerant distribution unit, and a second refrigerant distribution unit. Each of the first and second refrigerant distribution units include two opposite plates, respectively called channel plate and back plate, shaped to form channels for distributing refrigerant fluid in said thermal management system. The first refrigerant distribution unit and the second refrigerant distribution unit are fixed together. The first refrigerant distribution unit is disposed inclined relatively to the second refrigerant distribution unit.

This disclosure relates to a refrigerant module for a thermal management system.

### BACKGROUND ART

The development of electric vehicles has brought new issues to the automotive field, in particular in view of the limited autonomy of the electric battery as well as the limited space that can be dedicated to the thermal management system because of the positioning of the electric battery at the front of the vehicle. For these reasons, it is more and more searched for compact and light thermal management systems.

### SUMMARY

This disclosure improves the situation.

It is proposed a refrigerant module for a thermal management system, comprising a first refrigerant distribution unit, and a second refrigerant distribution unit, each of the first and second refrigerant distribution unit comprising two opposite plates, respectively called channel plate and back plate, shaped to form channels for distributing refrigerant fluid in said thermal management system, the first refrigerant distribution unit and the second refrigerant distribution unit being fixed together, the first refrigerant distribution unit being disposed inclined relative to the second refrigerant distribution unit.

The two refrigerant distribution units being mounted together, with a given angle between them, the refrigerant module as per the disclosure is compact and well adapted to equip an electric vehicle.

In another aspect, an angle between the first refrigerant distribution unit and the second refrigerant distribution unit is comprised in a range of values of 45° to 110°.

In another aspect, the angle between the first refrigerant distribution unit and the second refrigerant distribution unit is 90°.

In another aspect, the first refrigerant distribution unit comprises an interface configured to be fluidly connected to the second refrigerant distribution unit.

In another aspect, the interface comprises at least one opening for the refrigerant fluid to flow from one of the first and second refrigerant distribution units to the other of the first and second refrigerant distribution units.

In another aspect, the interface comprises a bar resting against the back plate of the second refrigerant distribution unit.

In another aspect, the first refrigerant distribution unit and the second refrigerant distribution unit are fixed together via the interface.

In another aspect, the interface comprises holes, called fixation holes, and the second refrigerant distribution unit comprises holes, called fixation holes, the fixation holes of the interface facing the fixation holes of the second refrigerant distribution unit to screw together the first refrigerant distribution unit and the second refrigerant distribution unit.

In another aspect, the interface and the second refrigerant distribution unit are brazed together.

The invention also related to a thermal management system comprising a refrigerant module as described above.

In another aspect, the thermal management system comprises a fluid source in fluid communication with and attached to the refrigerant module, the fluid source including at least one of a condenser, a chiller, a receiver-drier, a compressor or a coolant container.

In another aspect, the thermal management system comprises at least a valve attached to the first refrigerant distribution unit.

In another aspect, the fluid source is attached to the second refrigerant distribution unit.

In another aspect, the compressor has a discharge port directly connected to the first refrigerant distribution unit.

In another aspect the first refrigerant distribution unit is arranged to distribute the refrigerant fluid from the discharge port of the compressor to heat(s) exchanger(s) which receive the fluid of the compressor (in other words arranged upstream the compressor).

In other words, the channels dedicated to the relative high pressure and relative high temperatures are located in the first refrigerant distribution unit.

### BRIEF DESCRIPTION OF DRAWINGS

Other features, details and advantages will be shown in the following detailed description and on the figures, on which:

FIG. 1 is a perspective view of a bottom of a refrigerant module according to an embodiment of the present disclosure.

FIG. 2 is a perspective view of a top of the refrigerant module of FIG. 1.

FIG. 3 is a perspective view of the bottom of the refrigerant module of FIG. 1 according to a first alternative.

FIG. 4 is a perspective view of the bottom of the refrigerant module of FIG. 1 according to a second alternative.

### DESCRIPTION OF EMBODIMENTS

The present invention relates to a refrigerant module for a thermal management system, referred to as 1 in the figures. The refrigerant module comprises a first refrigerant distribution unit RU-1 and a second refrigerant unit RU-2. In the illustrated embodiment, the first refrigerant distribution unit RU-1 is smaller than the second distribution unit RU-2, though the invention is not limited to this arrangement.

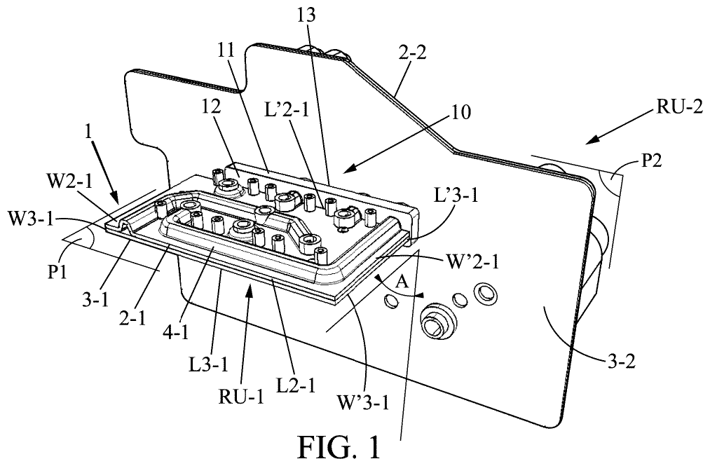

As can be seen from FIGS. 1, 3 and 4, the first refrigerant distribution unit RU-1 comprises two connected plates, a first plate 2-1 and a second plate 3-1, the two plates facing each other and fixed together. The first plate 2-1 comprises tracks and is later called refrigerant plate 2-1. The second plate 3-1 is essentially flat and is later called back plate 3-1. The refrigerant plate 2-1 and the back plate 3-1 are sealed together to delimit a closed space to form channels 4-1 of the refrigerant module 1.

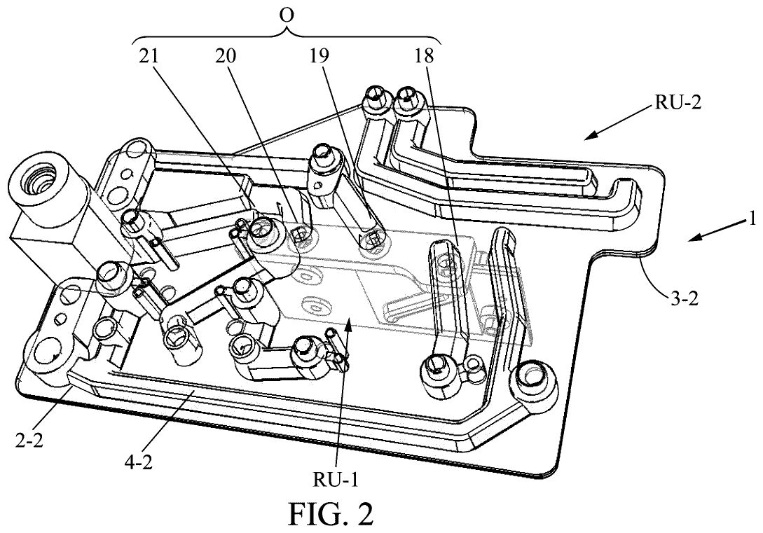

As can be seen from FIG. 2, the second refrigerant distribution unit RU-2 comprises two connected plates, a first plate 2-2 and a second plate 3-2, the two plates facing each other and fixed together. The first plate 2-2 comprises tracks and is later called refrigerant plate 2-2. The second plate 3-2 is essentially flat and is later called back plate 3-2. The refrigerant plate 2-2 and the back plate 3-2 are sealed together to delimit a closed space to form other channels 4-2 of the refrigerant module 1.

The channels 4-1, 4-2 ensure distribution of the refrigerant fluid in components of the thermal management system, like a compressor, an evaporator and/or a condenser (not shown).

Different components of the thermal management system can be attached to the first refrigerant refrigerant unit RU-1 and/or the second refrigerant distribution unit RU-2 like at least: a condenser and/or a water condenser and/or a heat exchanger (evaporator and/or chiller) and/or PT (pressure temperature) sensors, and/or valves and/o AC (air conditioning) lines.

As can be seen from the figures, the refrigerant plate 2-1 and the back plate 3-1 extend longitudinally along planes that are parallel to a plane referred to as P1. Similarly, the refrigerant plate 2-1 and the back plate 3-1 extend longitudinally along planes that are parallel to a plane referred to as P2 in the figures. P1 and P2 can respectively be defined as the first refrigerant distribution unit (longitudinal) plane and second refrigerant distribution unit (longitudinal) plane.

The planes P1 and P2 are inclined one to another with an angle referred to as A (FIG. 1). This arrangement ensures high compactness of the refrigerant module 1. It also guarantees that the refrigerant module 1 can be adapted to different kinds of vehicle front ends, even for electric vehicles, where the thermal management systems undergo many constraints relative to the packaging.

Advantageously, the angle A is comprised in the range of values of 45° to 110°, depending on the thermal management packaging. Preferably, the angle A is 90°, meaning that the planes P-1 and P-2 are perpendicular.

For example, the compressor has a discharge port directly connected to the first refrigerant distribution unit. The first refrigerant distribution unit is arranged to distribute the refrigerant fluid from the discharge port of the compressor to heat(s) exchanger(s) which receive the fluid of the compressor, in other words arranged just upstream the compressor. Thus, the channels dedicated to the relative high pressure and relative high temperatures are located in the first refrigerant distribution unit.

In the figures, the refrigerant plate 2-1 and the back plate 3-1 is a rectangular and extends between two couples of opposite edges, edges L2-1, L′2-1 representing lengths of the refrigerant plate 2-1 and edges W2-1, W′2-1 representing widths of the refrigerant plate 2-1. Similarly, the back plate 3-1 of the first refrigerant distribution unit RU-1 extends between two couples of opposite edges, edges L3-1, L′3-1 representing lengths of the back plate 3-1 and edges W3-1, W′3-1 representing widths of the back plate 3-2.

As can be seen from FIGS. 1, 3 and 4, the first refrigerant distribution unit RU-1 comprises an interface 10 to connect the first refrigerant distribution unit RU-1 to the second refrigerant distribution unit RU-2. The interface 10 comprises a rod 11 that has a general shape of a flat parallelepiped, even though the invention is not limited to this configuration.

The rod 11 comprises a front face 12 and a back face 13, the back face 13 being opposite to the front face 12. Each of the front face 12 and the back face 13 is delimited by lengths and widths of the rod 11.

As can be seen from the figures, the back face 13 of the rod 11 rests against the back plate 3-2 of the second refrigerant distribution unit RU-2.

The rod 11 is fixed to the two plates 2-1, 3-1 of the first refrigerant distribution unit RU-1, for instance is mounted integrally with the two plates 2-1, 3-1. The lengths of the rod 11 extend parallel to and are in contact with the edges L′2-1, L′3-1 of the refrigerant plate 2-1 and the back plate 3-1.

The rod 11 is provided with openings O that are configured to receive channels 4-2. The first refrigerant distribution unit RU-1 and the second refrigerant distribution unit RU-2 are configured to be directly connected thanks to the openings O. On the illustrated embodiment, the rod 11 comprises four openings O listed 18, 19, 20 and 21 (see FIG. 2).

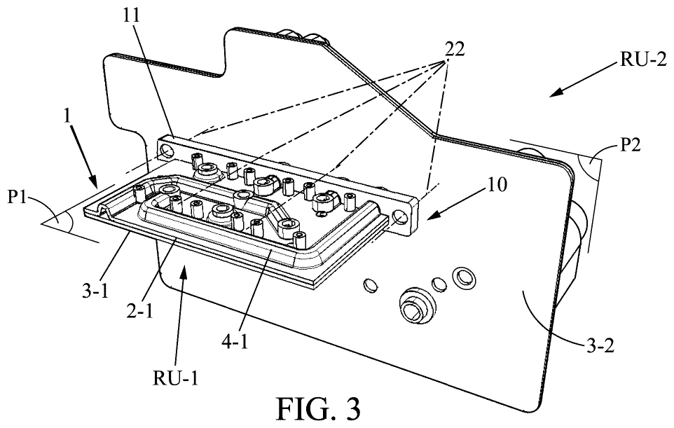

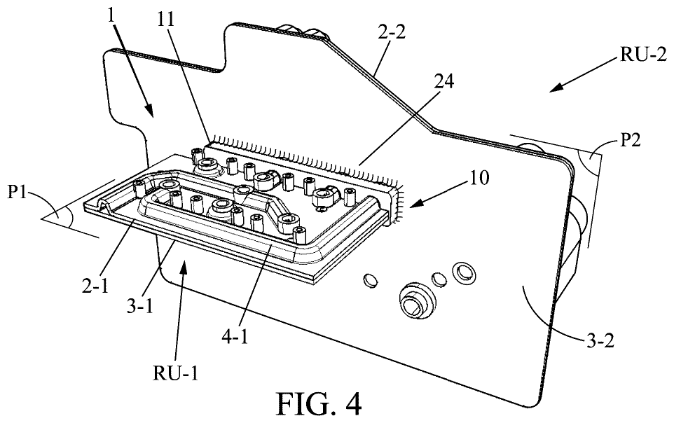

The first refrigerant distribution unit RU-1 and the second refrigerant distribution unit RU-2 are connected, either by a fixed connection (FIG. 3) or by a permanent joint (FIG. 4).

In FIG. 3, the first refrigerant distribution unit RU-1 and the second refrigerant distribution unit RU-2 are screwed together. The interface 10 comprises holes 22, called fixation holes, and the second refrigerant distribution unit RU-2 comprises holes 22, called fixation holes, the fixation holes of the interface facing the fixation holes of the second refrigerant distribution unit to screw together the first refrigerant distribution unit RU-1 and the second refrigerant distribution unit RU-2. In FIG. 3, the holes are represented by dotted lines.

In FIG. 4, the refrigerant module 1 comprises a brazed joint 24 between the first refrigerant distribution unit RU-1 and the second refrigerant distribution unit RU-2 around the interface 10. According to this alternative, the first refrigerant unit RU-1, including the interface 10, and the second refrigerant unit RU-2 are preferably made of aluminum, which allows a simple method of manufacturing with the brazing in one step.

The inclination of the refrigerant distribution unit implies that the thermal management (AC) loop can be defined as a three dimensional layout, inducing high-compactness and high-component density of the refrigerant module and of the air-conditioning system. The direct connection of the two refrigerant plates, without additional AC lines ensures a simple installation of the refrigerant module. Also, thanks to the two inclined directly connected refrigerant plates, the split and distribution of the AC components can be variable.

Please note that the invention is not limited to two refrigerant distribution units; the refrigerant module can be provided with more than two units.

1. A refrigerant module for a thermal management system, comprising:
a first refrigerant distribution unit; and
a second refrigerant distribution unit,
wherein each of the first and second refrigerant distribution units comprising two opposite plates, respectively called channel plate and back plate, shaped to form channels for distributing refrigerant fluid in said thermal management system,
wherein the first refrigerant distribution unit and the second refrigerant distribution unit being are fixed together, and
wherein the first refrigerant distribution unit being is disposed inclined relatively to the second refrigerant distribution unit.

2. The refrigerant module according to claim 1, wherein an angle between the first refrigerant distribution unit and the second refrigerant distribution unit is comprised in a range of values of 45° to 110°.

3. The refrigerant module according to claim 1, wherein the first refrigerant distribution unit comprises an interface configured to be fluidly connected to the second refrigerant distribution unit.

4. The refrigerant module according to claim 3, wherein the interface comprises at least one opening for the refrigerant fluid to flow from one of the first and second refrigerant distribution units to the other of the first and second refrigerant distribution units.

5. The refrigerant module according to claim 3, wherein the interface comprises a rod resting against the back plate of the second refrigerant distribution unit.

6. The refrigerant module according to claim 3, wherein the first refrigerant distribution unit and the second refrigerant distribution unit are fixed together via the interface.

7. The refrigerant module according to claim 6,
wherein the interface comprises holes, called fixation holes, and
wherein the second refrigerant distribution unit comprises holes, called fixation holes,
wherein the fixation holes of the interface facing the fixation holes of the second refrigerant distribution unit to screw the first refrigerant distribution unit and the second refrigerant distribution unit.

8. The refrigerant module according to claim 6, wherein the first refrigerant distribution unit and the second refrigerant distribution unit are brazed together.

9. A thermal management system, comprising the refrigerant module according to claim 1.

10. The thermal management system according to claim 9, comprising a fluid source in fluid communication with and attached to the refrigerant module, wherein the fluid source including at least one of a condenser, a chiller, a receiver-drier, a compressor or a coolant container.

11. The thermal management system according to claim 9, comprising at least a valve attached to the first refrigerant distribution unit.

12. The thermal management system according to claim 10, wherein the compressor has a discharge port directly connected to the first refrigerant distribution unit.

13. The thermal management system according to claim 12, wherein the first refrigerant distribution unit is arranged to distribute the refrigerant fluid from the discharge port of the compressor to heat(s) exchanger(s) which receive the fluid of the compressor.

14. The thermal management system according to claim 10, wherein the fluid source is attached to the second refrigerant distribution unit.
